(19) United States
(12) Patent Application Publication
(10) Pub. No.: US 2013/0315296 A1
(43) Pub. Date: Nov. 28, 2013

(54) SYSTEMS AND METHODS FOR ADAPTIVE SELECTION OF VIDEO ENCODING RESOURCES

(71) Applicant: Lei Zhang, Palo Alto, GA (US)

(72) Inventor: Lei Zhang, Palo Alto, GA (US)

(73) Assignee: BROADCOM CORPORATION, Irvine, CA (US)

(21) Appl. No.: 13/477,757

(22) Filed: May 22, 2012

(51) Int. Cl. H04N 7/32; H04N 7/44

(52) U.S. Cl. 375/240.02; 375/240.16; 375/E07.126; 375/E07.127; 375/E07.104

(57) ABSTRACT

Various embodiments for facilitating the adaptive selection of encoding tools in a video processing device. One embodiment, among others, is a method implemented in a video processing device for adaptively selecting video encoding tools. The method comprises receiving video data comprising a plurality of frames, determining a real-time available bandwidth associated with a dynamic random access memory (DRAM), and generating a feedback signal based on the determined real-time available bandwidth. An encoding resource is selected for processing at least a portion of the plurality of frames based on the feedback signal.

### BACKGROUND

Digital video capabilities may be incorporated into a wide range of devices including, for example, digital televisions, digital direct broadcast systems, digital recording devices, gaming consoles, digital cameras and many various handheld devices such as mobile phones. Video data may be received and/or generated by a video processing device and delivered to a display device such as, for example, a set-top-box where the video processing device may comprise a computer, a camera, disk player, etc. Uncompressed or compressed video may be transmitted from a video processing unit to a display or television using various media and/or formats. Current video encoding systems access a significant amount of data that is stored in dynamic random access memory (DRAM) because the cost for implementing on-chip memory to store all the data needed for the encoding process is prohibitively expensive.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a video processing device for facilitating the adaptive selection of encoding tools in accordance with various embodiments of the present disclosure.

FIG. 2 illustrates components of the motion estimation/motion compensation block in the video processing device of FIG. 1 in accordance with various embodiments of the present disclosure.

FIG. 3 is a detailed block diagram of the video processing device in FIG. 1 for facilitating the adaptive selection of encoding tools in accordance with various embodiments of the present disclosure.

FIG. 4 is a top-level flowchart illustrating examples of functionality implemented as portions of the video processing device of FIG. 1 for facilitating the adaptive selection of encoding tools according to various embodiments of the present disclosure.

FIG. 5 is a top-level flowchart illustrating examples of functionality implemented as portions of the video processing device of FIG. 1 for facilitating the adaptive selection of encoding tools according to other embodiments of the present disclosure.

FIG. 6 is a schematic block diagram of the video processing device in FIG. 1 according to an embodiment of the present disclosure.

### DETAILED DESCRIPTION

Various embodiments are disclosed for facilitating a smooth reduction in video encoding quality when the real-time bandwidth associated with memory for real-time scheduling (RTS) tasks is exceeded, thereby avoiding such undesirable effects as video glitches due to pictures being skipped. Real-time video encoding involves accessing video data in dynamic random access memory (DRAM) based on RTS so that a picture may be encoded within a given picture time frame without stalling other real-time tasks, such as decoding or displaying video or graphics and so that subsequent pictures may be encoded. However, real-time scheduling where a video encoder client must access a specific amount of data within a specific window of time is difficult to achieve in commercial real-time encoding or transcoding systems.

One reason is that other DRAM clients, such as a real-time graphics display or video decoder within an encoding or transcoding system, may have more stringent real-time performance requirements than the video encoder. Another reason is that the amount of data that an encoder needs to access varies from one picture to another or one coding unit to another. For example, the amount of data to be accessed for coding a 16×16 macroblock of uni-prediction (i.e., P-MB) is smaller as compared to coding a macroblock of bi-prediction (i.e., B-MB) as the amount of data to be accessed varies according to the coding unit and according to the encoding tool each coding unit selects via the encoder.

Implementing a DRAM system large enough to support RTS based on the worst case scenario is one option for meeting real-time requirements. However, this would likely lead to a DRAM system that is simply too costly to be competitive. Because of this, real-time video encoders are typically designed as a soft-RTS client that allocates to RTS clients a specific amount of data based on typical data access scenarios, where such soft-RTS clients may occasionally fail to meet real-time performance requirements but without interrupting operation.

With some current video encoder designs, the video encoder is configured to skip the encoding of subsequent pictures if the encoding of a picture cannot be completed within a picture time. This is performed in order to allow the video encoder to catch up with the real-time input of video data. However, one perceived shortcoming with this approach is that a visible video glitch will be observed during playback of the encoded video stream due to one or more pictures in the video sequence not being encoded. In this regard, a graceful means for decreasing the video encoding quality is preferred over the presence of visible glitches caused by skipping pictures.

Various embodiments are disclosed for real-time encoding that comprises adaptively selecting such encoding tools as bi-predictive coding versus uni-predictive coding based on real-time DRAM bandwidth availability. One embodiment, among others, includes a video processing device that comprises a video input processor configured to receive video data that includes a plurality of frames. The video system also includes a motion estimator for performing motion searches.

A random access memory in the video processing device is coupled to a memory controller, where the memory controller receives data requests from the motion estimator for fetching data from the DRAM. The video processing device also includes a memory access unit coupled to the DRAM, where the memory access unit is configured to determine a real-time available bandwidth associated with a DRAM. For some embodiments, the memory access unit is further configured to generate a feedback signal based on at least one random access memory data request generated by the motion estimator or other memory access clients such as a motion compensator. Based on the one or more feedback signals, one or more encoding tools are selected. In the following discussion, a general description of the system and its components is provided, followed by a discussion of the operation of the same.

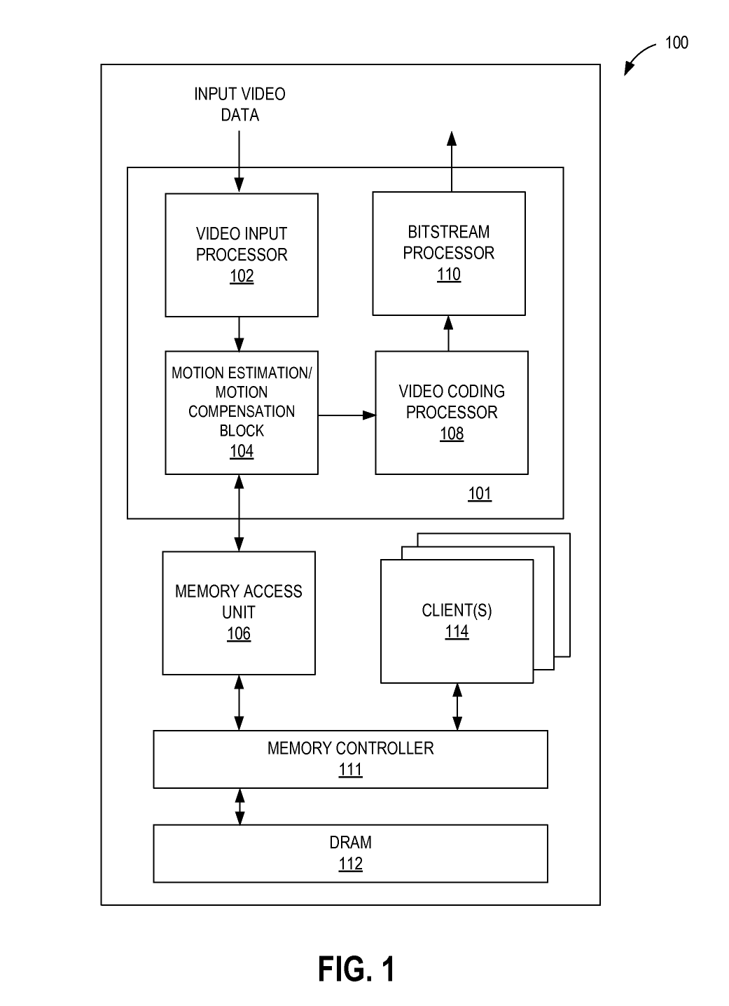

Reference is made to FIG. 1, which is a block diagram of a real-time video processing device for facilitating the adaptive selection of encoding tools in accordance with various embodiments. The video processing device 100 includes a video encoder 101, which includes a video input processor 102, a motion estimation/motion compensation block 104, a video coding processor 108, and a bitstream processor 110. The video input processor 102 is configured to capture and process input video data and transfers the video data to the motion estimation/motion compensation block 104, where the motion estimation/motion compensation block 104 analyzes the motion between the current macroblock of the input video picture and the reconstructed picture.

The motion estimation/motion compensation block 104 transfers the input video signal and the predicted video picture resulted from the motion analysis to the video coding processor 108, where the video coding processor 108 processes and compresses the video signal based on the motion analysis performed by the motion estimation/motion compensation block 104. The video coding processor 108 transfers the compressed video data to the bitstream processor 110, which formats the compressed data and creates an encoded video bitstream. The encoded video bitstream is output by the video encoding circuit 101. The video coding processor 108 further reconstructs the reference frame from the input frame and stores the reconstructed reference frame in DRAM 112. One of ordinary skill in the art will appreciate that the video encoding circuit 101 may comprise other components which have been omitted for purposes of brevity.

The video processing device 100 further comprises DRAM 112, which may be implemented, for example, as an off-chip memory relative to the video encoding circuit 101. The memory access unit 106 is configured to perform data block transfers from the DRAM 112 for the video encoding circuit 101. The memory controller 111 is configured to perform data transfers from the DRAM 112 for other clients 114 such as, for example, a graphics display or video decoder within the video processing device 100.

The memory access unit 106 is coupled to a memory controller 111, which fetches data from DRAM 112 for processing video data. For example, the memory controller 111 may retrieve a current frame macroblock and certain parts of the reference frames (i.e., a search region) from DRAM 112 and load the retrieved data into the motion estimation/motion compensation block 104. The motion estimation/motion compensation block 104 compares the current frame macroblock with the respective reference search region and generates an estimation of the motion of the current frame macroblock. This estimation is used to remove temporal redundancy from the video signal.

In comparison to existing encoder systems, embodiments of the video processing device 100 disclosed herein reduce the coding quality gracefully according to the available real-time DRAM 112 bandwidth. Furthermore, in accordance with various embodiments, the memory access unit 106 may allow the motion estimation processor 104 and/or other coding resources in the video encoder 101 to revert back to the previously selected encoding tool(s) in order to resume normal coding operations when sufficient DRAM 112 bandwidth for RTS becomes available in order to maximize video coding quality. For example, upon determination that real-time bandwidth becomes sufficient, the memory access unit 106 may generate a feedback signal notifying the motion estimation block 104 that bi-predictive coding may be re-enabled in order to provide better coding performance.

In accordance with some embodiments, the memory access unit 106 may be configured to constantly monitor for available bandwidth associated with DRAM 112. For other embodiments, the memory access unit 106 may be configured to poll the status of the memory controller 111 and the DRAM 112 according to a predetermined interval. Upon detection of a trigger event (e.g., when the requested data has not been returned from the DRAM 112 within a specific interval), the memory access unit 106 may detect whether the available bandwidth of DRAM 112 is sufficient.

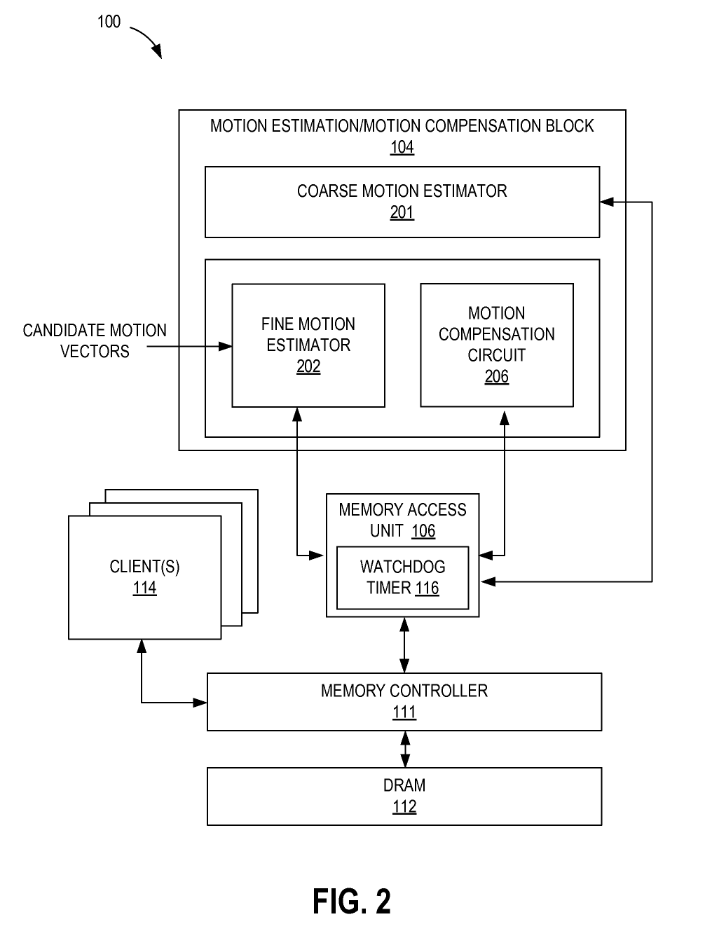

Reference is made to FIG. 2, which illustrates components of the motion estimation/motion compensation block 104 in the video processing device 100 of FIG. 1. During the encoding process, a current frame or picture in a group of pictures (GOP) is provided for encoding. The current picture may be processed on a macroblock level, where a macroblock corresponds, for example, to an N×N block of pixels in the original image. Motion estimation involves determining motion vectors that describe the displacement from one two-dimensional image to another, usually from adjacent frames in a video sequence. Motion compensation describes a picture in terms of the transformation of a reference picture to the current picture. The reference picture may be previous in time or even from the future.

In accordance with some embodiments, the reference data to be fetched from DRAM 112 and delivered to a motion estimation or motion compensation function is adaptively selected, thereby allowing the reference data to be fetched from DRAM 112 and delivered to the motion estimation/motion compensation block 104 to be determined as a function of real-time DRAM bandwidth. As shown, the motion estimation/motion compensation block 104 of the video encoder 101 (FIG. 1) may include a coarse motion estimator 201 and a fine motion estimator 202. The coarse motion estimator 201 is configured to estimate the current picture from one or more reference pictures using motion vectors in a coarse resolution unit.

The fine motion estimator 202 is configured to receive candidate motion vectors for searching motion vectors in the one or more reference blocks and may operate on partitions of a macroblock in the current picture. A temporally encoded macroblock may be divided into partitions, where each partition of a macroblock is compared to one or more prediction blocks of the same size in a search region at a motion vector resolution up to a quarter pixel.

Each macroblock may be encoded in only intra-coded mode for I-pictures, or either intra-coded or inter-coded mode for P-pictures or B-pictures. For these modes, a prediction macroblock may be formed on reconstructed pixels of a previous picture (i.e., inter-mode) or reconstructed pixels of encoded neighboring macroblocks of the current picture (i.e., intra-mode). In inter-mode, the predicted macroblock P may be generated based on the motion-compensated prediction from one or more reference frames.

In accordance with various embodiments, the adaptive selection of coding resources is performed based on one or more feedback signals generated by the memory access unit 106 based on data requests to the DRAM 112. For example, the memory access unit 106 may be configured to provide feedback signals to the motion estimation circuit 202 to perform either bi-prediction or uni-prediction motion search. The selection of bi-prediction mode results in two data requests from DRAM 112 to retrieve two reference data points, whereas selection of uni-prediction mode results in only a single data request. As shown, the memory access unit 106 may be configured to provide one or more feedback signals to a motion search engine 204 and a motion compensation circuit 206. Note, however, that feedback signals generated by the memory access unit 106 may be routed to other encoding tools within the video encoder 101. HEVC encoders, for example, may offer more encoding tools to select from relative to AVC encoders.

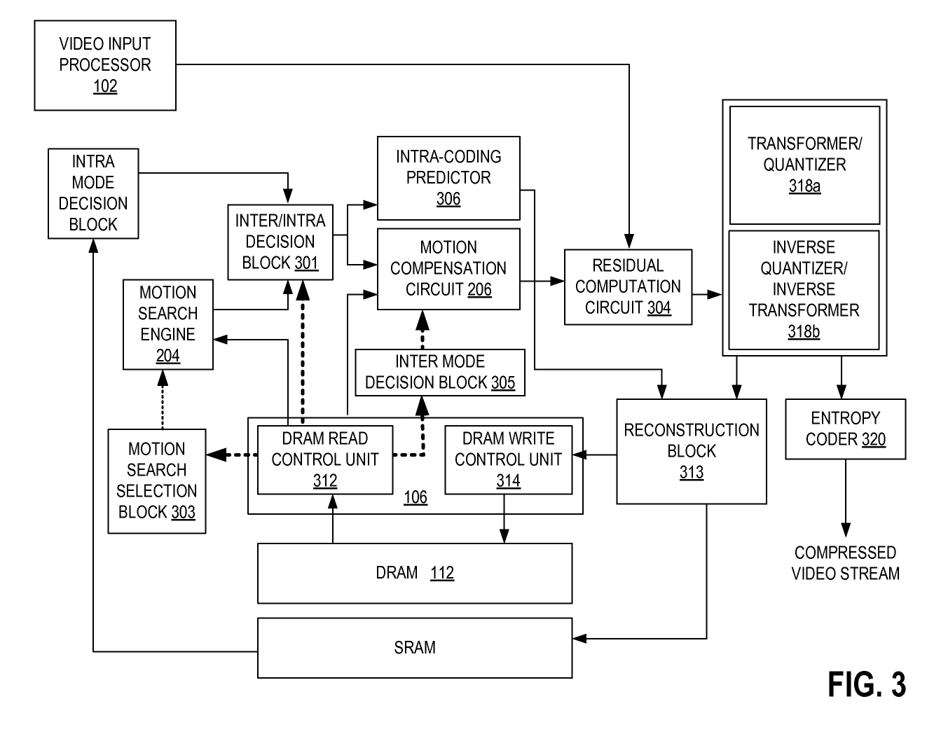

Reference is made to FIG. 3, which provides another detailed view of the video processing device 100 and represents just one possible implementation for adaptive selection of encoding tools. During the encoding process, a current frame or picture in a group of pictures (GOP) is provided for encoding. The current picture may be processed as macroblocks, where a macroblock corresponds to, for example, a 16×16 block of pixels in the original image. Each macroblock may be encoded in intra-coded mode or in inter-coded mode for P-pictures, or B-pictures. In inter-coded mode, the motion compensated prediction may be performed by the motion compensation circuit 206 and may be based on at least one previously encoded, reconstructed picture.

The predicted macroblock P may be subtracted from the current macroblock to generate a difference macroblock, and the difference macroblock may be transformed and quantized by the transformer/quantizer block 318a. The output of the transformer/quantizer block 318a may be entropy encoded by the entropy encoder 320 before being passed to the encoded video bit stream. Run-length encoding and/or entropy encoding are then applied to the quantized bitstream to produce a compressed bitstream which has a significantly reduced bit rate than the original uncompressed video data. The encoded video bit stream comprises the entropy-encoded video contents and any side information necessary to decode the macroblock. During the reconstruction operation performed by the reconstruction block 313, the results from the transformer/quantizer block 318a may be re-scaled and inverse transformed by the inverse quantizer/inverse transformer 318b block to generate a reconstructed difference macroblock. The prediction macroblock P may be added to the reconstructed difference macroblock.

In accordance with various embodiments, the adaptive selection of encoding tools may be implemented in the fine motion estimator 202 (FIG. 2), where the memory access unit 106 provides feedback signals, for example, for adaptively enabling or disabling the bi-prediction search of an N×N macroblock (e.g., a 16×16 macroblock) for a B-picture or two reference search for a P-picture. In general, the feedback signals may provide such information as whether the fine motion estimator 202 is accessing more data than what is subscribed to the DRAM 112 according to RTS tasks. By disabling the bi-prediction search of subsequent 16×16 macroblocks for a B-picture or two reference search for a P-picture, the amount of data the fine motion estimator 202 and the subsequent Motion Compensation (MC) block need to access from the DRAM is significantly reduced.

In accordance with various embodiments, the memory access unit 106 is configured to monitor activity by the memory controller 111 and provide one or more feedback signals to the motion estimation/motion compensation block 104. These feedback signals allow the motion estimation/motion compensation block 104 to adaptively reduce or increase data accesses to the DRAM 112 by directing the selection of encoding tools used for the encoding process. In operation, the memory access unit 106 monitors the amount of data accessed to DRAM 112 during the encoding of the remaining coding units of the current picture based on such criteria as the latency associated with fulfilling data requests and the amount of real-time data requested in comparison to what is subscribed according to RTS, thereby allowing the video encoder 101 to meet real-time performance requirements for encoding a picture within the window of time for the picture frame. For some embodiments, the memory access unit 106 further comprises a watchdog timer 116 for monitoring the latency associated with fulfilling data requests by the memory controller 111 and DRAM 112.

In accordance with some embodiments, the memory access unit 106 may also monitor whether the amount of data requested exceeds the subscribed budget set aside for motion estimation/motion compensation block 104 as each RTS client of the same DRAM is assigned a budget in terms of the amount of data that may be accessed by the RTS client from the DRAM 112 within a specific period. Thus, if the amount of requested data exceeds the subscribed budget for the motion estimation/motion compensation client, the memory access unit 106 generates a feedback signal reflecting this.

As shown in the example implementation of FIG. 3, the memory access unit 106 includes a DRAM read control unit 312 and a DRAM write control unit 314. For some embodiments, the DRAM read control unit 312 within the memory access unit 106 is configured to send a feedback signal comprising a motion search selection to the motion search engine 204, where the motion search selection indicates, for example, whether to enable or disable bi-predictive searches. Based on the feedback signal from the memory access unit 106 to the motion search engine 204, the motion search engine 204 then performs data accesses to DRAM 112 for the next coding unit according to the selected search mode.

For some embodiments, the fine motion estimator 202 may revert back to bi-predictive or two-reference searches (from uni-prediction reference searches) upon determination by the memory access unit 106 that the amount of data accessed from DRAM 112 by such components as the fine motion estimator and motion compensation circuit 206 meets real-time scheduling requirements. As also shown, the memory access unit 106 is further configured to generate a feedback signal that specifies the selection of inter-coding versus intra-coding, where the feedback signal is further forwarded to the inter/intra mode decision block 301 prior to the intra-coding predictor 306 and the motion compensation circuit 206, where by selecting intra-mode instead of inter-mode for the current macroblock, DRAM access by the motion compensation circuit 206 is not required for the current macroblock, thereby reducing data access to the DRAM 112. The residual computation circuit 304 generates residual transform coefficients.

The various embodiments disclosed may be applied to adaptively select coding parameters such as, but not limited to, a search range and resolution level for fine motion estimation. Note that the various embodiments disclosed may be applied to various video standards, including but not limited to, MPEG-2, VC-1, VP8, and HEVC, which offers more encoding tools to select from. For example, with HEVC, the inter-prediction unit size can range anywhere from a block size of 4×4 up to 32×32, which requires a significant amount of data to perform motion search and motion compensation.

Note also that the various embodiments directed to selection of coding tools are not limited to the selection of bi-predictive coding versus uni-predictive coding. Other coding parameters or coding sources that may be selected based on available DRAM 112 bandwidth may include the size of the coding unit associated with a generalized B-picture in HEVC in addition to the selection of intra-coding or inter-coding, the selection of bi-prediction versus uni-prediction for inter-coding, the selection of a single reference search versus a two reference search for uni-prediction coding, and so on. Other encoding tools or parameters that may be selected include the search range for coarse motion estimation, the number of references in coarse motion estimation searches, the frame motion vector range or resolution that reduces the amount of data access to the DRAM 112, a partition size for reducing the amount of data to be accessed by the macroblock or coding unit, and so on.

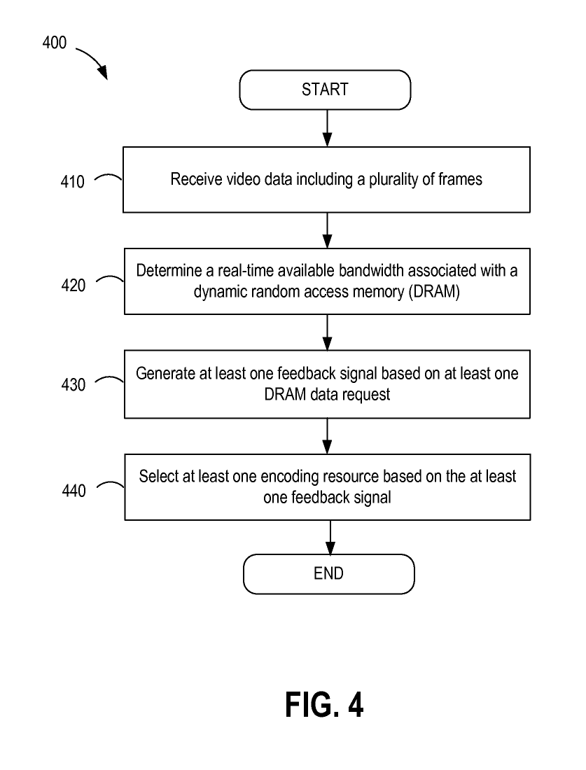

Reference is made to FIG. 4, which is a flowchart 400 in accordance with one embodiment for facilitating the adaptive selection of encoding tools within the video encoder 101 (FIG. 1) executed in the video processing device 100 (FIG. 1). It is understood that the flowchart 400 of FIG. 4 provides merely an example of the various different types of functional arrangements that may be employed. As an alternative, the flowchart 400 of FIG. 4 may be viewed as depicting an example of steps of a method implemented via execution of the video processing device 100 according to one or more embodiments.

In accordance with one embodiment for facilitating selection of encoding tools, the video processing device 100 begins with block 410 and receives video data comprising a plurality of frames. In block 420, the memory access unit 106 (FIG. 1) in the video processing device 100 determines the real-time available bandwidth associated with DRAM 112 (FIG. 1). For some embodiments, the memory access unit 106 determines whether insufficient bandwidth associated with DRAM 112 persists whereby the video encoder is not able to process video data within a window of time.

In block 430, the memory access unit 106 generates at least one feedback signal based on one or more data requests to DRAM 112. The one or more feedback signals may correspond, for example, to a search range/resolution level for fine motion estimation, a minimum block partition size for performing motion searches and motion compensation, coding unit size, the selection of intra-coding versus inter-coding, the selection of bi-prediction versus uni-prediction for inter-coding, the selection of a single reference search versus a two reference search for uni-prediction coding, and so on.

In block 440, the at least one encoding resource is selected based on the at least one feedback signal. For example, the memory access unit 106 may send a motion search selection feedback signal to the motion search selection block 303 that controls the motion search engine 204 (FIG. 3). As another example, the memory access unit 106 may send a feedback signal to the inter-mode decision block 305 that controls the motion compensation circuit 206. Based on the feedback signal received from the memory access unit 106, the corresponding components in the video encoder (e.g., the motion search engine 204, motion compensation circuit 206) processes video data and accesses DRAM 112 based on the encoding resource specified by the feedback signal originating from the memory access unit 106.

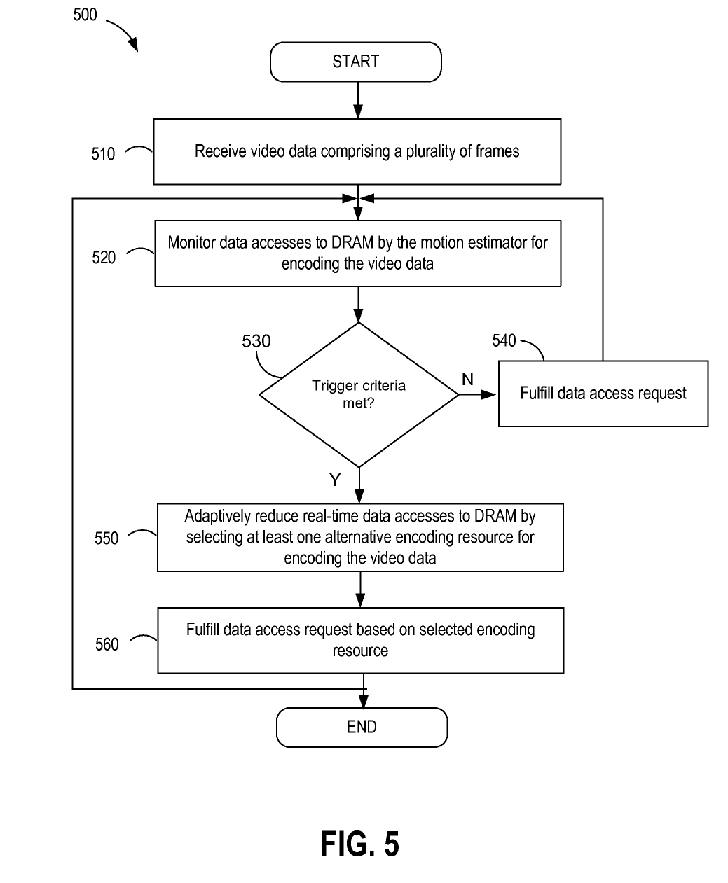

Reference is made to FIG. 5, which is a flowchart 500 in accordance with another embodiment for facilitating the adaptive selection of encoding tools within the video encoder 101 (FIG. 1) executed in the video processing device 100 (FIG. 1) for encoding video data. It is understood that the flowchart 500 of FIG. 5 provides merely an example of the various different types of functional arrangements that may be employed. As an alternative, the flowchart of FIG. 5 may be viewed as depicting an example of steps of a method implemented via execution of the video processing device 100 according to one or more embodiments.

In accordance with one embodiment for facilitating selection of encoding tools, the video processing device 100 begins with block 510 and receives video data comprising a plurality of frames. In block 520, the memory access unit 106 (FIG. 1) in the video processing device 100 monitors data accesses to DRAM 112 (FIG. 1) by the motion estimation/motion compensation block 104 (FIG. 1). In decision block 530, a determination is made on whether one or more trigger criteria is met. The trigger criteria may comprise, for example, the latency associated with the at least one DRAM data request exceeding a predetermined value. The trigger criteria may also comprise DRAM 112 bandwidth usage exceeding a predetermined level.

In block 540, if the trigger criteria is not met, then the feedback signal may indicate that reduction of coding resources is not necessary, and the data request is fulfilled by the memory controller 111 (FIG. 1). Flow then returns back to block 520 where the memory access unit 106 continues to monitor the data accesses to DRAM 112. Returning back to decision block 530, if the trigger criteria is met, then in block 550, the video encoder 101 adaptively reduces the real-time access to DRAM 112 based on feedback from the memory access unit 106. In particular, encoding tools are selected back on the feedback provided by the memory access unit 106. In block 560, the data access request is fulfilled based on the selected encoding tools. Flow then returns back to block 520, where the memory access unit 106 continues to monitor memory accesses of DRAM 112.

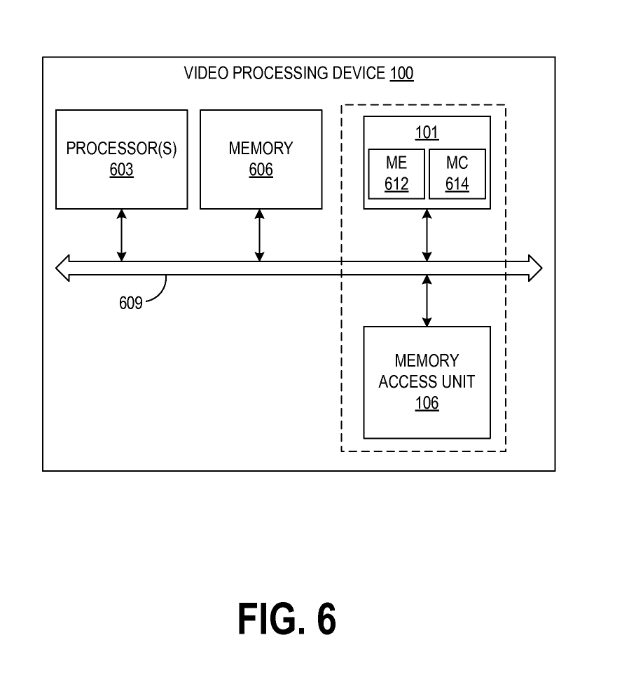

FIG. 6 is a schematic block diagram of a video processing device 100 according to various embodiments of the present disclosure. The video processing device 100 includes at least one processor circuit, for example, having a processor 603, a memory 606, a video encoder 101, a memory access unit 106, all of which are coupled to a local interface 609. To this end, the video processing device 100 may comprise, for example, at least one computing device or like device. The video encoder 101 includes, among other components, a motion estimation block 612 and a motion compensation block 614, as described earlier. The local interface 609 may comprise, for example, a data bus with an accompanying address/control bus or other bus structure as can be appreciated.

Note that while the video encoder 101 and the memory access unit 106 are shown as being integrated in the video processing device 100, these components may also be implemented as components external to the video processing device 100. Furthermore, the video encoder 101 and/or memory access unit 106 may be implemented as a board level product, as a single chip, application specific integrated circuit (ASIC), and so on. Alternatively, certain aspects of the present invention are implemented as firmware.

Stored in the memory 606 are both data and several components that are executable by the processor 603. It is understood that there may be other systems that are stored in the memory 606 and are executable by the processor 603 as can be appreciated. A number of software components are stored in the memory 606 and are executable by the processor 603. In this respect, the term “executable” means a program file that is in a form that can ultimately be run by the processor 603.

Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), and/or other memory components, or a combination of any two or more of these memory components. In addition, the RAM may comprise, for example, static random access memory (SRAM), dynamic random access memory (DRAM), or magnetic random access memory (MRAM) and other such devices.

Also, the processor 603 may represent multiple processors 603 and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction. In one embodiment, the processor 603 and memory 606 may correspond to a system-on-a-chip.

Although the video encoder 101, memory access unit 106, and other components described herein may be embodied in software or code executed by general purpose hardware as discussed above, as an alternative, the same may also be embodied in dedicated hardware or a combination of software/general purpose hardware and dedicated hardware. If embodied in dedicated hardware, each component may be implemented as a circuit or state machine that employs any one of or a combination of a number of technologies. These technologies may include, but are not limited to, discrete logic circuits having logic gates for implementing various logic functions upon an application of one or more data signals, ASICs having appropriate logic gates, or other components, etc. Such technologies are generally well known by those skilled in the art and, consequently, are not described in detail herein.

The flowcharts of FIGS. 4 and 5 show the functionality and operation of an implementation of portions of the video processing device 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 603 in a computer system or other system. The machine code may be converted from the source code, etc. If embodied in hardware, each block may represent a circuit or a number of interconnected circuits to implement the specified logical function(s).

Although the flowcharts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. Further, in some embodiments, one or more of the blocks shown in FIGS. 4 and 5 may be skipped or omitted. It is understood that all such variations are within the scope of the present disclosure.

Also, any logic or application described herein that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a video processing device for adaptively selecting video encoding tools, comprising:
receiving video data comprising a plurality of frames;
determining a real-time available bandwidth associated with a dynamic random access memory (DRAM) based on DRAM data requests;
generating a feedback signal based on the determined real-time available bandwidth; and
based on the feedback signal, selecting an encoding resource for processing at least a portion of the plurality of frames.

2. The method of claim 1, wherein generating the feedback signal comprises determining latency associated with the DRAM data requests.

3. The method of claim 1, further comprising performing a subsequent DRAM request upon selecting the encoding resource, wherein the subsequent DRAM request corresponds to a reduced amount of data to be retrieved from DRAM relative to a DRAM request corresponding to a previously selected encoding resource.

4. The method of claim 1, wherein the DRAM data requests are associated with real-time scheduling (RTS) tasks.

5. The method of claim 4, wherein generating the feedback signal comprises comparing a bandwidth associated with the DRAM data requests with a subscribed budget bandwidth associated with the RTS tasks.

6. The method of claim 4, wherein generating the feedback signal comprises comparing a total amount of data requested from the DRAM with a predetermined threshold, wherein at least a portion of the total amount of data corresponds to an amount of data requested from the DRAM by at least one of a motion estimator or motion compensator in the video encoder.

7. The method of claim 6, wherein the predetermined threshold corresponds to a total DRAM bandwidth allocated for the RTS tasks.

8. The method of claim 1, wherein selecting the encoding resource based on the feedback signal comprises selecting one of a single reference data for performing uni-prediction encoding or a plurality of reference data for performing bi-prediction encoding of the video data.

9. The method of claim 1, wherein selecting the encoding resource based on the feedback signal comprises selecting one of intra-coding, predicted coding, uni-prediction encoding, or bi-directional coding of the video data.

10. The method of claim 9, further comprising enabling bi-predictive searching of a macroblock in response to selection of bi-directional coding.

11. The method of claim 9, further comprising searching for a plurality of reference frames in response to selection of predicted coding.

12. A video system, comprising:
a video input processor configured to receive video data comprising a plurality of frames;
a motion estimator configured to perform motion estimation on the received video data;
a motion compensator configured to perform inter-prediction on the received video data;
a random access memory coupled to a memory controller, the memory controller being configured to receive data requests from at least one of the motion estimator or the motion compensator; and
a memory access unit coupled to the memory controller, the memory access unit being configured to determine a real-time available bandwidth associated with a random access memory, the memory access unit further configured to generate a feedback signal based on random access memory data requests by at least one of the motion estimator or the motion compensator, the memory access unit further configured to select an encoding mode based on the feedback signal.

13. The system of claim 12, wherein the memory access unit is further configured to generate the feedback signal based on latency associated with the random access memory data requests.

14. The system of claim 12, wherein at least one of the motion estimator or motion compensator accesses the random access memory based on the selection of the encoding resource.

15. The system of claim 12, wherein the memory access unit is configured to generate the feedback signal based on a total number of pending random access memory requests corresponding to real-time scheduling (RTS) tasks.

16. The system of claim 12, wherein the encoding mode comprises one of intra-coding, uni-prediction coding, or bi-directional coding.

17. The system of claim 16, wherein the memory access unit is configured to select one of intra-coding, uni-prediction coding, or bi-directional coding based on comparison of a real-time available bandwidth associated with a random access memory with a predetermined threshold corresponding to real-time scheduling (RTS) tasks.

18. The system of claim 17, wherein the memory access unit is further configured to select intra-coding upon determination that the required real-time bandwidth associated with a random access memory is greater than the predetermined threshold.

19. A method implemented in a video processing device for adaptively selecting video encoding tools, comprising:
receiving video data comprising a plurality of frames;
monitoring data accesses to a dynamic random access memory (DRAM) by a memory access unit for encoding the video data and other real-time scheduling (RTS) clients, and
based on the monitored data accesses to the DRAM, adaptively reducing data accesses to the DRAM by at least one of a motion estimator or a motion compensator by selecting an encoding resource for encoding the video data.

20. The method of claim 19, wherein selecting the encoding resource comprises selecting one of intra-coding, uni-prediction coding, or bi-directional coding of the video data.

21. The method of claim 19, wherein intra-coding is selected upon determining that data accesses to the DRAM by at least one of the motion estimator or the motion compensator exceeds a predetermined threshold, wherein the threshold corresponds to RTS tasks associated with at least one of the motion estimator or the motion compensator.

22. The method of claim 21, wherein the predetermined threshold corresponds to a subscribed RTS budget assigned to at least one of the motion estimator or the motion compensator.

23. The method of claim 19, wherein adaptively reducing data accesses to the DRAM by at least one of the motion estimator or the motion compensator is performed based on feedback signals generated by the memory access unit.
